(19) United States
(12) Patent Application Publication
(10) Pub. No.: US 2025/0068408 A1
(43) Pub. Date: Feb. 27, 2025

(54) PROPAGATING AUTHORED PACKAGES TO ASSET MANAGEMENT PLATFORMS

(71) Applicant: MAINTAINX INC., Miami, FL (US)

(72) Inventors: Stefan Cristian Turlica, Miami, FL (US); Hugo Dozois-Caouette, Miami, FL (US); Mathieu Marengère-Gosselin, Montreal (CA)

(21) Appl. No.: 18/236,288

(22) Filed: Aug. 21, 2023

(51) Int. Cl. G06F 8/65

(52) U.S. Cl. CPC G06F 8/65

(57) ABSTRACT

Techniques for propagating a package from a package authoring platform to an asset management platform are disclosed. A service generates a digital twin for an asset. The service receives, from the package authoring platform, a package that is associated with the asset. The package outlines a set of governing criteria for the asset. The service transmits the package to the asset management platform. The service receives, from the asset management platform, telemetry data that indicates operational conditions associated with the asset. The service uses the telemetry data to determine compliance with the governing criteria of the package.

### BACKGROUND

The phrase “software distribution” generally refers to the process of propagating programs, program updates, or other types of program packages to an end user of the program. As an example, a set of developers may design an application. Once the application is designed, the application is distributed or rolled out to end users who may then use the application. Often, new updates to the application may be developed. These updates can be similarly distributed to users of the application. By distributing or propagating software packages, end users can enjoy the benefits of an up-to-date application.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a method for propagating a package from a package authoring platform to an asset management platform, said method being implemented by a service and including: generating a digital twin for an asset, wherein the digital twin is a digital representation of the asset; receiving, from the package authoring platform, a package that is associated with the asset, wherein the package outlines a set of governing criteria for the asset; transmitting the package to the asset management platform; receiving, from the asset management platform, telemetry data that indicates operational conditions associated with the asset; and using the telemetry data to determine compliance with the governing criteria of the package.

In some aspects, the techniques described herein relate to a computer system that propagates a package from a package authoring platform to an asset management platform, said computer system including: a processor system; and a storage system that stores instructions that are executable by the processor system to cause the computer system to: generate a digital twin for an asset, wherein the digital twin is a digital representation of the asset; receive, from the package authoring platform, a package that is associated with the asset, wherein the package outlines a set of governing criteria for the asset; transmit the package to the asset management platform; receive, from the asset management platform, telemetry data that indicates operational conditions associated with the asset; and use the telemetry data to determine compliance with the governing criteria of the package.

In some aspects, the techniques described herein relate to a method for propagating a package from a package authoring platform to an asset management platform, said method being implemented by a service and including: generating a digital twin for an asset, wherein the digital twin is a digital representation of the asset; receiving, from the package authoring platform, a package that is associated with the asset, wherein the package outlines a set of governing criteria for the asset; transmitting the package to the asset management platform; receiving, from the asset management platform, telemetry data that indicates operational conditions associated with the asset; using the telemetry data to determine compliance with the governing criteria of the package; receiving, from the package authoring platform, an update to the package such that an updated package is received; and transmitting the updated package to the asset management platform.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example scenario involving an asset in the form of equipment.

FIG. 2 illustrates an example architecture for authoring, transmitting or propagating, and implementing an authored package.

FIG. 3 illustrates various examples of data describing an asset.

FIG. 4 illustrates various examples of data describing a package.

FIG. 5 illustrates an example of an embedded package.

FIG. 6 illustrates an example of an option to accept, reject, or postpone updates to a package.

FIG. 7 illustrates various assets and sensors.

FIG. 8 illustrates how a sensor can monitor various conditions for an asset.

FIG. 9 illustrates another scenario where a sensor is monitoring conditions.

FIG. 10 illustrates an example in which the layout of an asset is being analyzed.

FIG. 11 illustrates an example in which a recommendation for a new layout is provided.

FIG. 12 illustrates an example where sensor data is being used to generate an alarm or alert.

FIG. 13 illustrates an example user interface.

FIG. 14 illustrates another example user interface.

FIGS. 15A and 15B illustrate flowcharts of an example method for propagating an authored package.

FIG. 16 illustrates an example computer system that can be configured to perform any of the disclosed operations.

### DETAILED DESCRIPTION

Many industries, such as the manufacturing industry, rely on different assets (e.g., units of equipment) to operate. As various examples, these units may include conveyor belts, climate control systems (e.g., HVAC), pressurized equipment, and so on. It is often mission critical for consumers that their equipment operates correctly, predictably, and safely.

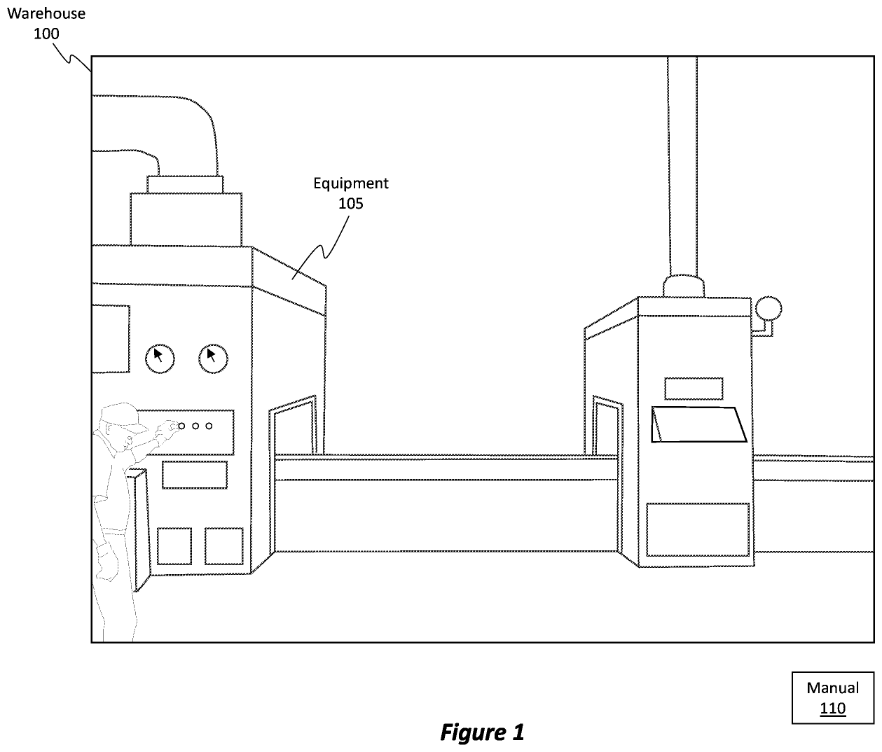

To help ensure that the equipment operates as intended, the manufacturers of the equipment typically provide the consumer with user or maintenance guides. These guides often come in the form of large binders of paper detailing all of the instructions related to a unit of equipment. FIG. 1 is illustrative.

FIG. 1 shows a warehouse 100 that includes a unit of equipment 105. A manual 110 is typically provided to a technician operating the equipment 105. The manual 110 details how to use and service the equipment 105. The manual 110 also often details the inventory of parts for the equipment 105, including potentially how to obtain spare parts. In some cases, the manual 110 may include a vendor list detailing which vendors are able to provide which parts. The manual 110 also often includes maintenance schedules for the equipment 105 and how to troubleshoot failures.

Historically, it has been very challenging to search through the manual 110 to find out how to resolve issues. As mentioned earlier, it is often the case that the manual 110 is a binder comprising a large number of paper documents. Searching through such a binder is often a challenge. Also, it is often the case that the manual 110 is periodically updated by the manufacturer of the equipment. Updating the manual 110 also results in challenges when it is presented in this traditional format.

These historical practices are also quite reactive in their design. For instance, preventative care on equipment is often overlooked because such care is often buried in the large expanse of the manual 110, and consumers of the equipment (e.g., technicians or other users) are often not aware of some of the preventative measures they should take.

Another issue that has plagued the traditional technology is that manufacturers are often unable to track their fleet of equipment. Once the equipment leaves the manufacturer, it is often the case that manufacturers are no longer able to help in establishing maintenance schedules or in assisting in finding spare parts.

Stated differently, physical hardware has historically been distributed along with paper documentation detailing how the hardware works, how to operate the hardware, how to maintain the hardware, and how to troubleshoot issues. In some cases, information will also be provided regarding vendors that can service the hardware and how to obtain spare parts.

As a specific example, consider an espresso machine. The instruction manual for this unit will detail how to set it up for the first time. Then, indications on cadence, parts and procedures required to descale it will also be provided. It is likely that a guide on how to interpret error codes or what physical latches to examine will be provided. Lastly, a list of approved vendors might also be provided to service the equipment and/or to install spare parts.

In the industrial space, it is often the case that more advanced and expensive equipment are used. Because of the cost of obtaining a new unit, it is often desirable to maximize an existing unit's efficiency and lifetime as well as to minimize its downtime. Yet, the paradigm of setting up the equipment, maintaining it, troubleshooting it, and eventually upgrading it is strikingly similar to the one in the consumer space in that almost everything is managed via paper.

That being said, all of these processes are magnified in their scope for the industrial space. For instance, the documentation for an industrial unit often comes in the form of a large paper binder that is inches thick and that attempts to handle every possible scenario around maintenance (both preventive and reactive). Consumers are provided a vast sea of information that is easy to get lost in. When updates occur, the manual often needs to be reprinted, updated, or otherwise patched to account for new changes or adjustments.

What often happens is that consumers end up failing to properly maintain their units, thereby potentially reducing that unit's optimal lifetime and potentially costing millions of dollars for early replacements. If the unit goes down, it can take much longer to troubleshoot and repair, which in turn can also represent large financial losses for the consumer.

Moreover, the equipment manufacturer has little-to-no visibility over how their equipment is used (or misused) across their customer base. Manufacturers often cannot anticipate or detect chronic issues or defects before they cause downtime or injuries. Manufacturers also cannot use this as an efficient channel to service the equipment “just in time” or to replace or upgrade parts strategically.

Finally, regulating bodies, such as OSHA (Occupational Safety and Health Administration), are also mostly left in the dark. They are not able to monitor all the equipment usage in all facilities all of the time.

What is needed, therefore, is an improved technique for managing assets (e.g., equipment) in a manner that is actionable as opposed to reactionary. What is further needed is a technique for enabling manufacturers to better track their fleet of equipment. In effect, there is a substantial need to connect consumers and manufacturers so that these two entities can better manage and maintain various assets. The disclosed embodiments are designed to satisfy these needs as well as many others.

In view of the above problems, it has been observed that there are various parallels between hardware and software. For example, both require an initial setup, instructions to operate, instructions to troubleshoot, and procedures to account for updates. Both can be regulated by external bodies. Both can be used as a building blocks in a bigger component (e.g., a compressor in an HVAC can be likened to a library used to compress images in a photo editor). Individual pieces of equipment can be building blocks for an even bigger component, such as a factory.

With that observation, it is purported that hardware can be serviced in a similar way as software is serviced using such concepts as proper methodology, proper toolkits, correct paradigms, and improved mentality. Software is notorious for receiving frequent updates, covering things such as security, performance, and feature revisions. Software is often composed of other software and libraries, which in turn can also receive frequent updates. Software also frequently reports metrics through anonymous telemetry to a code developer. This telemetry data is then used to analyze crashes, defects, usage, and other activities. That information can be very valuable to educate what issues to address first, what patterns to avoid in the future, which ones to double down on, and even what to build next. The disclosed embodiments are able to manage hardware in a manner that is similar to how software is managed.

In this regard, the disclosed embodiments provide numerous benefits, advantages, and practical applications to at least the technical field of asset management. Such improvements are achieved by managing hardware assets in a dynamic and flexible manner, similar to how software assets are managed.

As one example, the embodiments beneficially provide a centralized service that is able to receive authored packages from manufacturers and propagate those packages to consumers of the asset. These packages include information related to an asset such as procedures for the asset, vendor lists for the asset, parts for the asset, or any other information related to maintaining, operating, or troubleshooting the asset. These packages can be updated and distributed in real time, without the severe latency that was involved in traditional practices.

Similar to how software systems are deployed and maintained, the disclosed embodiments employ related principles for the care and management of physical assets, such as equipment. As an example, an initial version of a manual may be deployed. When updates to that manual are authored by the manufacturer, the disclosed service is able to receive those updates and then propagate them to the various consumers who have the corresponding asset. The disclosed service is further able to operate in conjunction with existing asset management tools to receive up-to-date information about the various units of equipment being used by each consumer. The service can receive and maintain this information and can optionally even provide it to the manufacturer. Using this received information (e.g., telemetry data), the manufacturer can then better track the states of the equipment in their fleet. Thus, a two-way update process occurs; with information being supplied from the OEM to the customer and with other information being supplied from the customer to the OEM.

Beneficially, information for an asset (e.g., an equipment manual) can now be updated in real time. The various procedures, preventative care, and maintenance can also beneficially be updated in real time. As another benefit, the disclosed service is able to receive feedback from consumers tasked with using the disclosed information. That feedback can then be used to facilitate further updates, if so desired. As one example, it may be the case that a technician is performing actions defined in an updated manual. The technician may discover a slight improvement in how the operations are performed, so the technician may provide this feedback to the service. A new update package can then be authored based on the feedback provided from the technician.

In this regard, the disclosed solutions beneficially aim to allow hardware manufacturers to deploy, update, and monitor their equipment horizontally to all their customers in a manner similar to how software is maintained. To achieve this objective, the disclosed embodiments are directed to a package authoring and delivery system that enables operations related to defining and regrouping the various components used for the proper deployment and servicing of hardware assets. Examples of such components include, but are not limited to, assets, parts, vendors, sensors, procedures (such as standard operating procedures, maintenance and troubleshooting instructions, regulatory compliance, etc.), and work order templates (e.g., preventive maintenance, corrective actions, pre-configured recommendations).

Using these solutions, when hardware manufacturer's customer has a new piece of hardware installed, rather than a cumbersome paper binder, the hardware's information is now delivered as a software package that can be installed in the customer's preferred environment (e.g., an asset management platform). Installing the software package can be as easy as scanning a QR code on the hardware, a URL, or any other selectable link. Beneficially, one way in which the package operates is that each component inside the package points to an origin symbol (e.g., procedure or other data) that can be referenced by all installed versions. This allows for a multitude of benefits, including selectivity, overriding, composition, update management, logging and monitoring, and eventually contributing. Accordingly, these and many other benefits and improvements will now be discussed in more detail throughout the remaining portions of this disclosure.

### Example Architecture

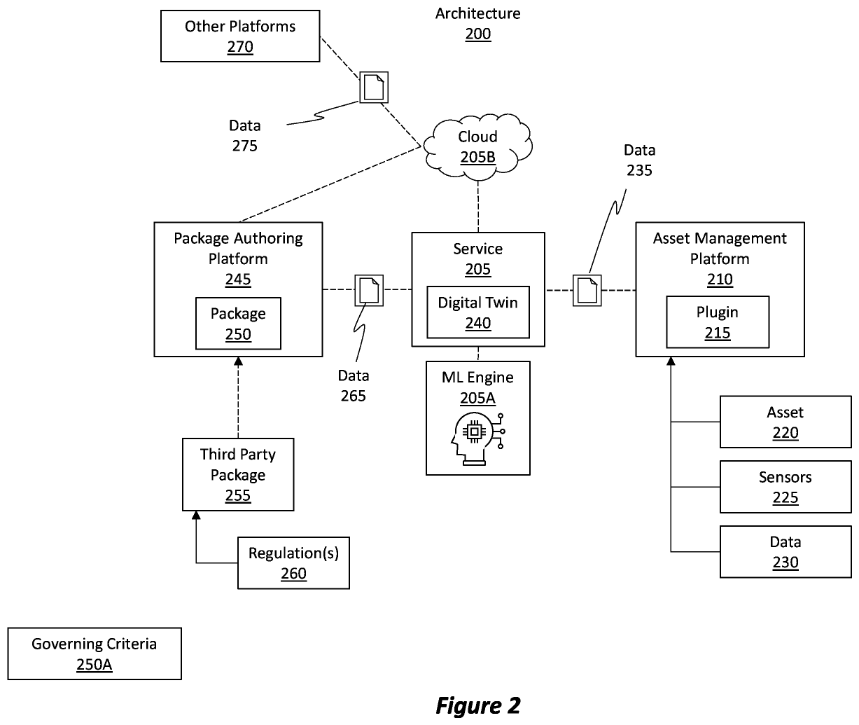

Having just described a few example benefits, attention will now be directed to FIG. 2, which illustrates an example architecture 200 that can be used to achieve those benefits. Initially, architecture 200 is shown as including a service 205.

As used herein, the term “service” refers to an automated program that is tasked with performing different actions based on input. In some cases, service 205 can be a deterministic service that operates fully given a set of inputs and without a randomization factor. In other cases, service 205 can be or can include a machine learning (ML) or artificial intelligence engine, such as ML engine 205A. ML engine 205A enables service 205 to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 205 is a cloud service operating in a cloud environment 205B. In some implementations, service 205 is a local service operating on a local device. In some implementations, service 205 is a hybrid service that includes a cloud component operating in the cloud environment 205B and a local component operating on a local device. These two components can communicate with one another.

Service 205 communicates with an asset management platform 210 used by a consumer of an asset. To do so, a plugin 215 is often installed in the asset management platform 210, and the plugin 215 is used to facilitate the communications between service 205 and the asset management platform 210. Stated differently, in some scenarios, the asset management platform 210 includes a plugin 215 component that facilitates communications between the asset management platform 210 and the service 205, and the service 205 may be a cloud service.

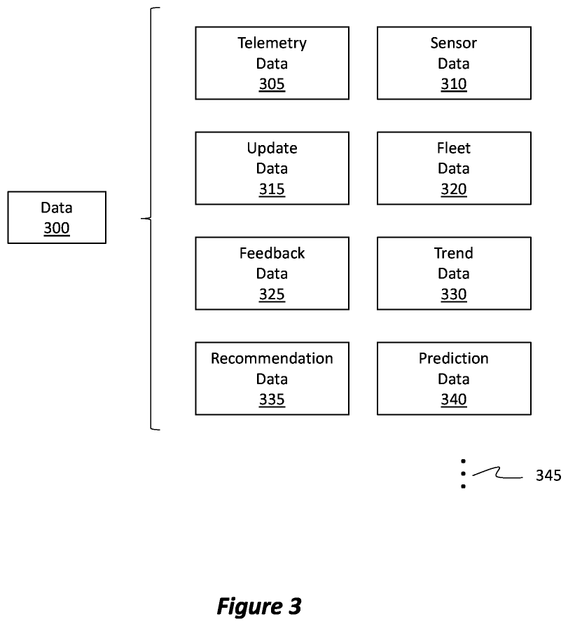

Generally, the asset management platform 210 is a tool, service, application, or any other type of platform used by asset consumers to manage their assets, such as asset 220. In some cases, the asset management platform 210 is able to acquire sensor data from sensors 225 that are monitoring the asset 220. In some cases, any other type of data 230 can be obtained by the asset management platform 210 for the asset 220. The asset management platform 210 acquires this data and is then able to transmit it to the service 205, as shown by data 235. FIG. 3 provides some additional details regarding the data 235.

FIG. 3 shows data 300, which is representative of the data 235 from FIG. 2. Data 300 can include data sent from a consumer to the service or from the service to the consumer. Examples of data 300 include, but are not limited to, any type of telemetry data 305, sensor data 310, update data 315, fleet data 320, feedback data 325, trend data 330, recommendation data 335, or prediction data 340. The ellipsis 345 demonstrates how other data may be included as well.

The telemetry data 305 refers to data describing the operational characteristics of an asset. Such characteristics may include run time, down time, service time, output produced, maintenance times, inspections, flags and failures, labor time, repair costs, part costs, any other costs, and so on.

The sensor data 310 refers to data obtained from sensors that are tasked with monitoring the conditions associated with the asset. Such data may include the environmental conditions in which the asset is operating, the internal conditions of the asset (e.g., temperature, pressure, etc.), or any other type of sensor data.

The update data 315 refers to data describing how or when a package for an asset was authored, is updated, or will subsequently be updated. Notably, the package can include any type of information about an asset. In some cases, the package includes the asset's manual, or a digital twin of the manual. In some cases, the package purposefully omits the manual because the package already includes the details from the manual, but those details are in a different format (e.g., perhaps in the format of a standard operating procedure, or a parts list, or a vendor list). Thus, in some cases, the disclosed service analyzes the package and analyzes the manual. The service is able to identify redundant or duplicate material and selectively determine whether to include that redundant material in the package or exclude it from the package. The disclosed package may thus include any content from the asset's manual as well as additional information, such as, but not limited to, standard operating procedures (SOPs), parts maintenance schedules, spare parts, and/or vendor information. The package can be authored by an original equipment manufacturer (OEM), and the package may be periodically updated. The authored package and the updates can be transmitted to a customer. Thus, the described package can be viewed as being a bundle of information that is delivered, such as over a network, to a customer. The authoring and update of a package can occur without a dependency on which clients have an asset. Rather, after the package is authored or updated, the disclosed service can identify which clients have the asset and then deliver the package or the update. Therefore, in accordance with the disclosed principles, the embodiments are able to maintain an authored package and are able to update the package in real time. Accordingly, the update data 315 may include updates from the manufacturer for the authored package.

The fleet data 320 refers to data describing which manufacturer's fleet an asset may be included in. For instance, a particular manufacturer may deploy many units of the same type of equipment to many different consumers. The fleet data 320 can describe to which fleet a consumer's asset belongs. In some cases, the manufacturer may transmit data to the consumers to describe various conditions associated with a fleet of equipment.

The feedback data 325 refers to data generated at the consumer end. Technicians or other workers may be tasked with performing various actions. Inasmuch as those workers are closest to the asset, it is often the case that those workers identify or derive improved processes for operating on or with those assets. The workers can then provide feedback data 325 to the manufacturers, and that feedback data may trigger the update of a manual, such as perhaps a service manual.

The trend data 330 refers to data describing various behavioral trends identified for an asset or a group of assets. As an example, a manufacturer can acquire fleet data describing operational characteristics of a particular type of asset. That data can be analyzed to detect patterns or trends in behavior, thereby producing the trend data 330. It may be advantageous for consumers to be apprised of this trend data 330; thus, the trend data 330 can be sent to the consumers.

Recommendation data 335 refers to various recommendations that may be generated by one or more of the consumer or the manufacturer. This data can be used to update practices and other procedures.

Prediction data 340 refers to data that has been generated and that relates to a prediction as to how an asset may subsequently operate. For instance, the prediction data 340 may predict that a particular part of an asset will likely expire within an upcoming time period, and so that part should be pre-ordered and be ready to be replaced.

Returning to FIG. 2, the data 235 is transmitted from the asset management platform 210 to the service 205. Using that data 235, service 205 is able to generate a so-called “digital twin” 240 of the asset 220. As used herein, the phrase “digital twin” generally refers to a digital representation of an asset. As an example, if the asset is a piece of equipment, the digital twin can include a digital representation of that asset. In some cases, the digital twin may include a computer generated representation of the size shape and physical characteristics of the asset, such as a model of the asset. The digital twin 240 may further include operational characteristics of the asset as well as potentially a physical location of the object, including perhaps its proximity to other objects in an environment. The digital twin 240 may include additional metadata or descriptive information about the asset as well, such as the manual for the asset and/or any of the other information described herein.

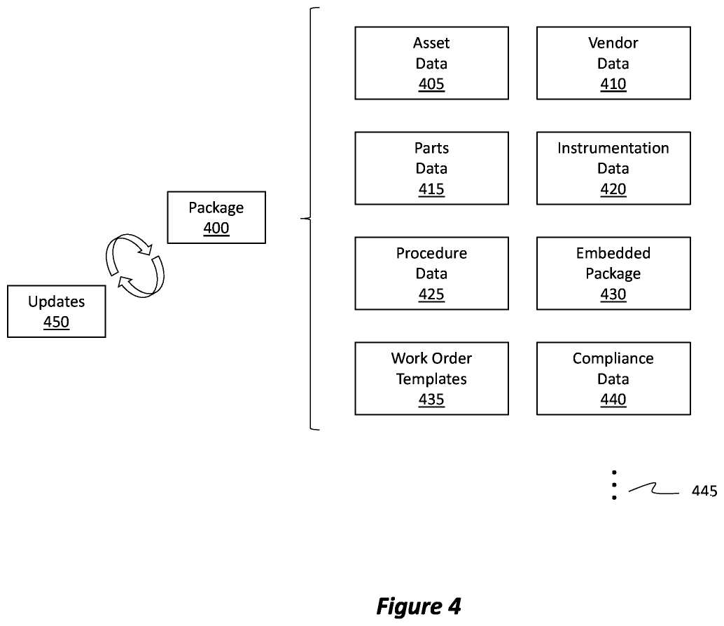

FIG. 2 also shows how service 205 is able to communicate with a package authoring platform 245. Often, this package authoring platform 245 belongs to or is otherwise associated with a manufacturer of an asset, such as an original equipment manufacturer (OEM). The platform 245 provides a framework or tool to enable developers to author a package 250 that can be transmitted to the asset management platform 210. Package 250 outlines a set of governing criteria 250A for the asset 220. FIG. 4 provides further details regarding the package 250.

FIG. 4 shows a package 400, which is representative of package 250 from FIG. 2. Package 400 may include, but is not limited to, data that includes any one or more of the following: asset data 405, vendor data 410, parts data 415, instrumentation data 420, procedure data 425, embedded package 430, work order templates 435, or compliance data 440. The ellipsis 445 demonstrates how other information or data can be included in the package 400 as well.

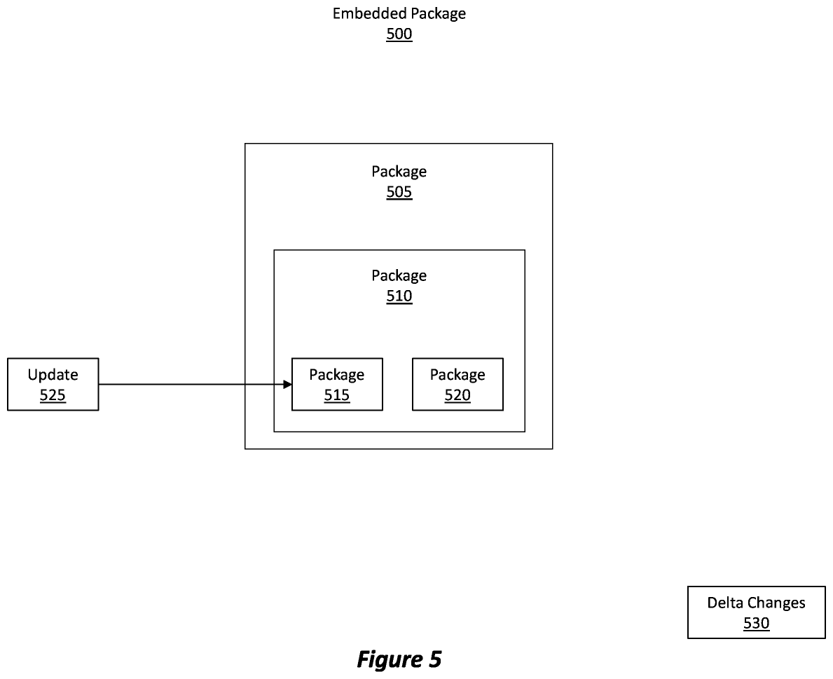

Asset data 405 refers to any data about an asset. Such data can include how it operates, where it operates, when it operates, weight, size, and so on. Vendor data 410 refers to any data about vendors who can service the asset. Parts data 415 refers to any data about parts that the asset may use. Instrumentation data 420 refers to any data about sensors or other instrumentation associated with the asset, including data generated by those sensors. Procedure data 425 refers to any data describing procedures for the asset. Embedded package 430 refers to a package that has at least one other packaged embedded inside of it. FIG. 5 is illustrative.

For example, FIG. 5 shows an embedded package 500, which is representative of embedded package 430 from FIG. 4. Embedded package 500 is shown as including a first package 505. Embedded inside of package 505 is another package 510. Embedded inside of package 510 are two other packages, such as package 515 and package 520. The embodiments are able to provide updates to the entire embedded package 500 and/or to individual packages embedded inside of another package, as shown by update 525. Furthermore, the embodiments are able to track the specific changes that are made and to log these changes in an audit log. Delta changes 530 refers to the specific changes or deltas that exist between one version of a package and an updated version of that package.

An example of an embedded package will be helpful. Package 505 may be a package that is developed by a manufacturer of an asset. Often, certain assets are regulated by a governing authority. These governing authorities may have a set of guidelines or requirements that certain assets are to meet. Those requirements may be included in a package that is authored by the governing authority. The package 505 may thus include another package authored by a different entity (e.g., the governing authority). For instance, package 510 may be the package authored by the governing authority. Thus, a package may include any number of embedded other packages, and those other packages may be authored by different entities.

Returning to FIG. 4, work order templates 435 refers to templates that may be generated for an asset. Finally, compliance data 440 refers to compliance requirements an asset may need to abide by.

An initial package may be authored and transmitted to the asset management platform. Later, various updates 450 may be made, and those updates 450 can likewise be transmitted.

Returning to FIG. 2, package authoring platform 245 is able to provide a framework for authoring the package 250. Additionally, or alternatively, a package can be authored by a third-party and provided to the platform 245, as shown by third party package 255. In some cases, this third party package 255 may include specialized details regarding specific regulation(s) 260 for an asset. That third party package 255 can optionally be embedded in another package or it can eventually be delivered to the asset management platform 210 as is.

In any event, the platform 245 is able to transmit its packages to the service 205. Data 265 represents the authored package being delivered to the service 205.

Architecture 200 may further include or may communicate with any number of other platforms 270, such as platforms associated with other OEMs. These other platforms 270 are similarly able to transmit data 275 to the service 205. Furthermore, all of these units of data can be used to analyze trends in fleet data.

As another benefit, service 205 is able to generate a corpus of data that describes the various assets and how they are being used. Overtime, service 205 (and in particular the ML engine 205A) is able to identify trends and patterns and help facilitate the production of updated packages to be sent to the asset management platform 210. These packages include updated information on how to operate, maintain, or otherwise use the asset 220.

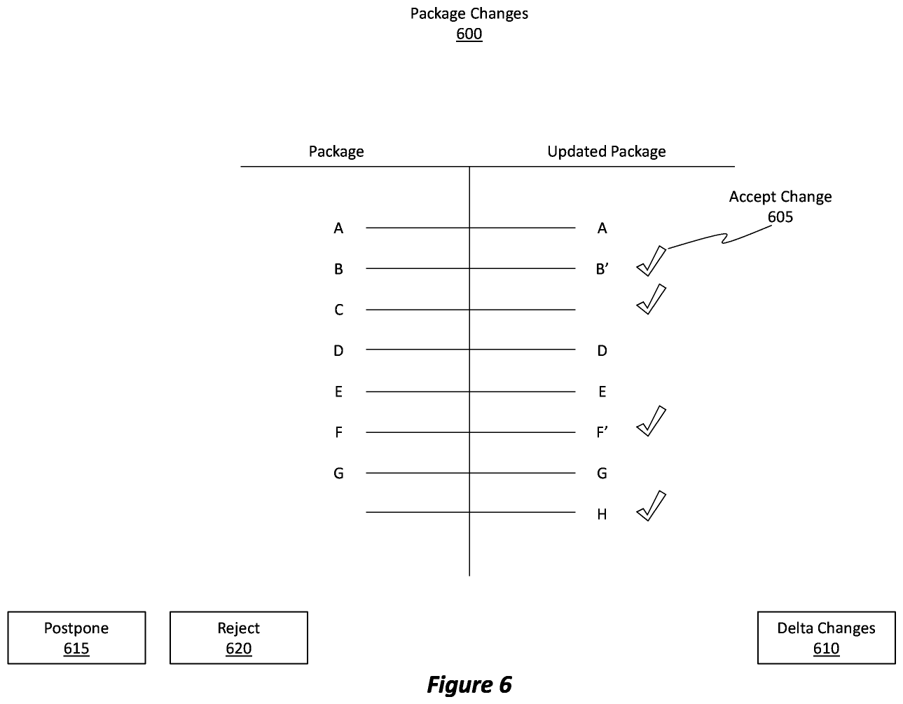

FIG. 6 shows an example scenario in which deltas or package changes 600 can be tracked and transmitted to a consumer for review and/or approval for incorporation into that consumer's asset. For example, FIG. 6 shows a first version of a package (listed under the label “package”) and an updated version of that package (listed under the label “updated package”).

The original package include features A, B, C, D, E, F, and G. The updated package includes features A, B′, D, E, F′, G, and H. This updated package can be transmitted to a consumer to review and/or accept the updates. For instance, in FIG. 6, the checkmarks next to line items 2, 3, 6, and 8 (corresponding to original features B, C, F, and newly added H) indicate that the consumer has accepted the updates, as shown by accept change 605.

In some instances, the consumer can elect to postpone 615 the incorporation of a new set of updates. In other instances, the consumer can elect to reject 620 the new updates. In yet other scenarios, the consumer can elect to accept the new updates. In any event, the consumer is made aware of the delta changes 610 that exist between one version of a package and an updated version of that package.

### Using Sensor Data

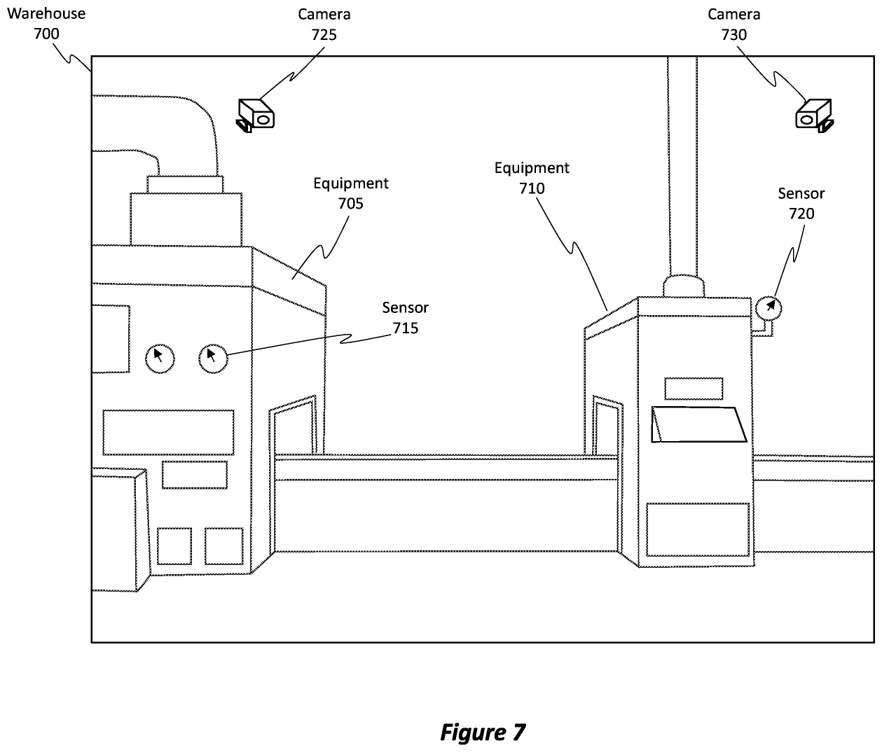

FIGS. 7 through 12 illustrate various example scenarios in which sensor data and other types of data are being used by the disclosed embodiments. FIG. 7 shows an example warehouse 700 that includes multiple units of equipment, such as equipment 705 and equipment 710 (i.e. assets). Warehouse 700 also includes multiple sensors, such as sensor 715, sensor 720, camera 725, and camera 730. These various sensors and equipment are being managed by the asset management platform 210 of FIG. 2. For instance, the equipment 705 and 710 can be included as assets (e.g., asset 220 of FIG. 2) tracked by the asset management platform 210. Similarly, the sensors 715 and 720 and cameras 725 and 730 can be included among the sensors 225 of FIG. 2.

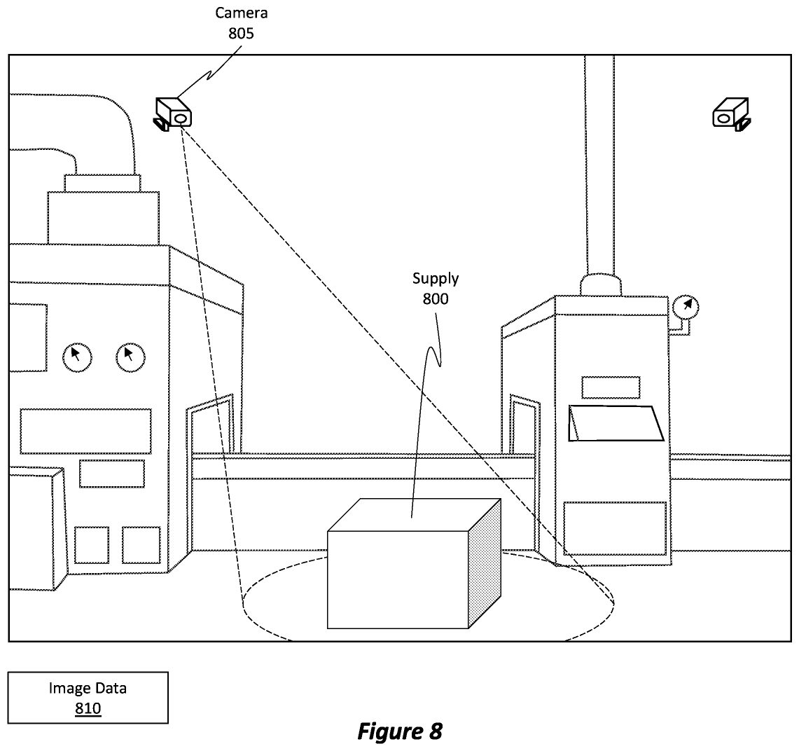

FIG. 8 shows an example of a supply 800 that is used by any of the equipment mentioned earlier. In this example scenario, camera 805 is generating image data 810 about the supply 800.

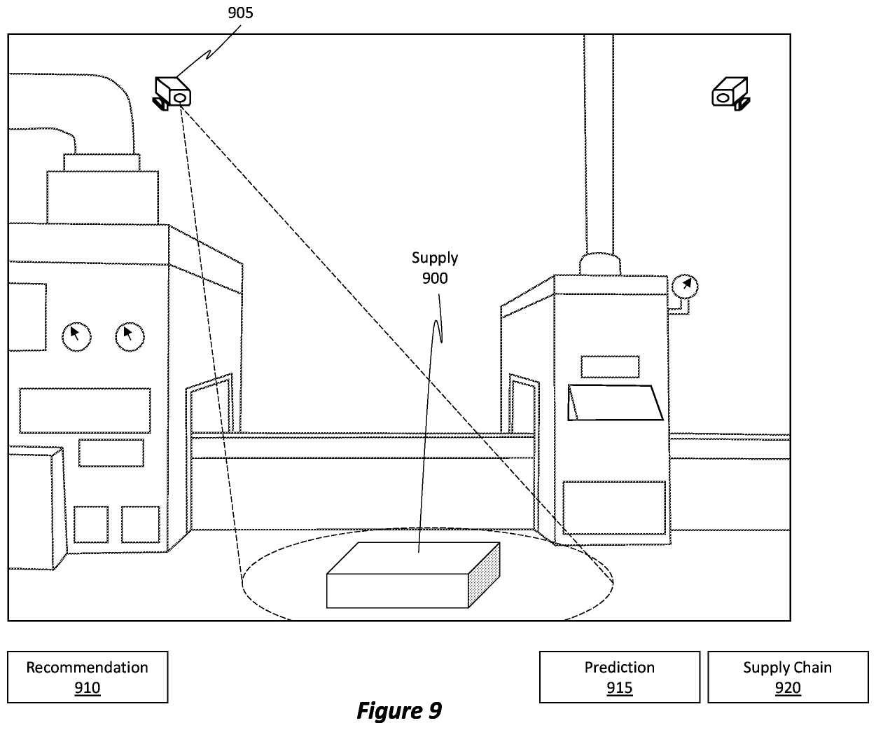

FIG. 9 shows a scenario where the supply 900 is now lower than supply 800 of FIG. 8. Here, camera 905 has been tracking the supply 900. The resulting image data can be transmitted to the service 205 of FIG. 2. Service 205 can analyze the sensor data to generate a recommendation 910 or a prediction 915 with respect to the supply chain 920 for that supply 900. For instance, based on the monitored levels of the supply 900, service 205 may predict that the supply 900 will run out by a certain date. Similarly, service 205 may generate a recommendation that more of the supply 900 should be obtained prior to that date so that the equipment can continue to operate.

While the above example focused on a scenario involving the analysis of image data to generate a prediction and a recommendation, one will appreciate how any type of sensor data can be used. Indeed, any type of measurement or sensor data can be used. In some cases, the analysis of that data may be performed by the ML engine mentioned earlier. As a specific example, the ML engine can analyze the image data to detect the usage of a supply over time and to determine when more of that supply should be ordered. In some cases, the sensor data may be non-image data or non-computer vision data, such as gauge data or any other type of data. In some cases, the sensor data can be used by the service to determine how much inventory currently is available or is likely needed in the future.

As one example, consider a scenario where a lightbulb is broken. A sensor can detect this broken lightbulb. Additionally, or alternatively, a work order may reflect that the lightbulb has been replaced by a technician. The disclosed service is able to analyze the work order and detect that a new bulb from inventory was used to replace the broken bulb. The service may then reflect the change in its inventory database. Thus, in some scenarios, data obtained from non-sensor data may be used, one example of which is data obtained from a document or form, such as a work order. In some scenarios, technician input or feedback can also be used to trigger updates to inventory or parts.

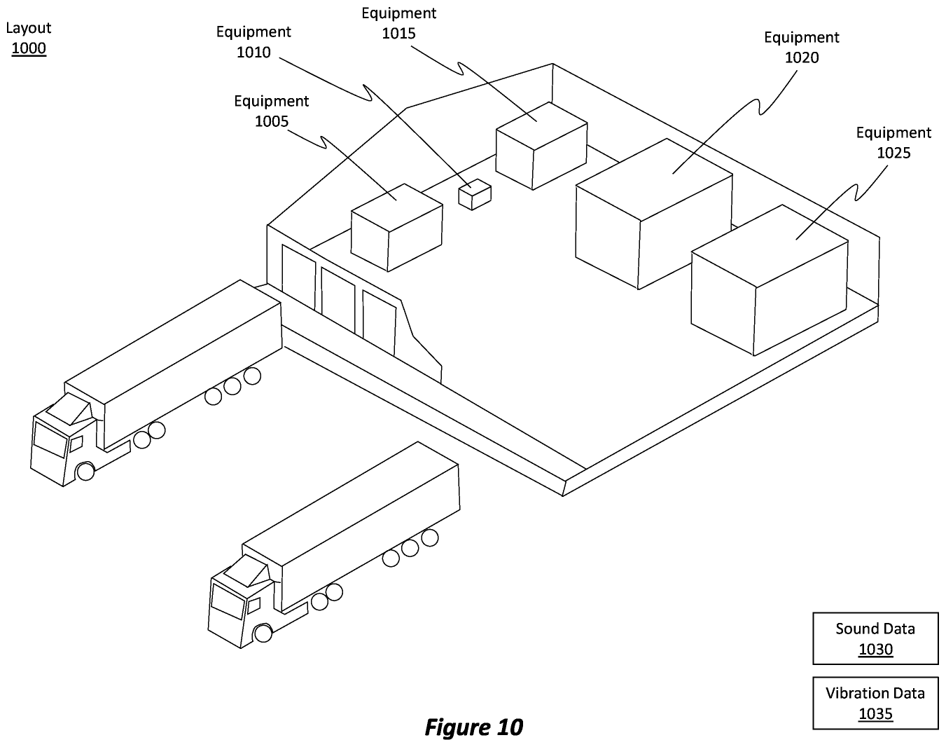

FIG. 10 shows an example layout 1000 of a warehouse that includes multiple units of equipment, such as equipment 1005, 1010, 1015, 1020, and 1025. Information describing the layout of these various units (e.g., perhaps image data, model data, or layout data) can be provided to the service 205, and the service 205 can perform an analysis to determine whether that layout 1000 is optimal for those specific units of equipment. In some cases, additional data can be acquired, such as sound data 1030 and/or vibration data 1035.

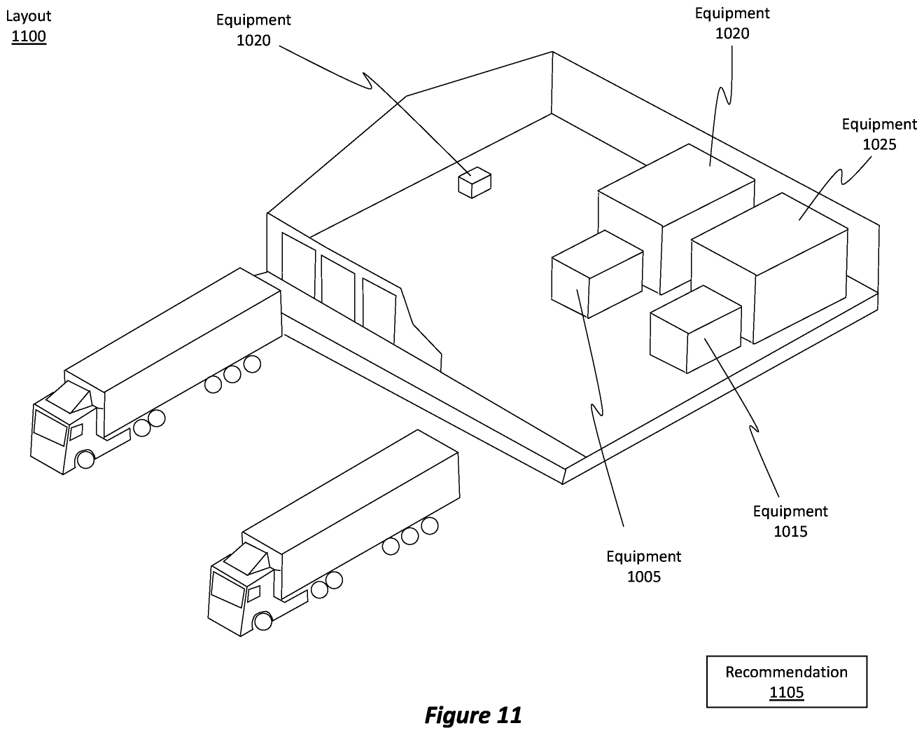

It may be the case that one unit of equipment is particularly sensitive to vibrations. If that unit was located proximately to another unit that vibrated, then that placement or layout may not be ideal. The disclosed service is able to analyze the placement or layout of the various units of equipment in a facility, and the service (e.g., particularly the ML engine) may submit a recommendation as to a more optimal layout for the equipment. In another scenario, other recommendations or other types of recommendations can be generated. As some examples, the service can generate a recommendation that is related to a schedule for a service or a recommendation relating to content of a service procedure. Recommendations related to parts, inventory, or any type of scheduling can be generated. FIG. 11 is illustrative of the initial layout example.

Having analyzed the previous layout, service 205 submitted a new recommendation 1105 for a new layout 1100, which is now implemented in FIG. 11. Layout 1100 shows the new placement of the equipment 1005, 1010, 1015, 1020, and 1025. This new layout 1100 may take into account vibration sensitivities, noise sensitivities, climate conditions, sunlight conditions, or any other parameter. Accordingly, the disclosed service is not only able to propagate updates to manuals and other information for an asset, but it also includes intelligence for improving how assets are physically disposed relative to other assets and other positional constraints.

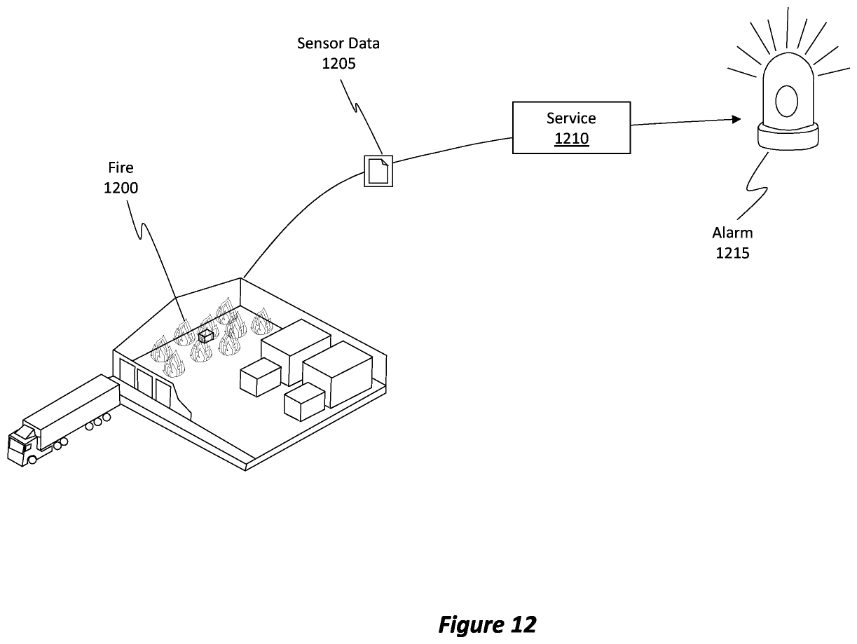

FIG. 12 shows another example scenario in which sensor data is acquired and analyzed. In FIG. 12, a fire 1200 is currently happening in the warehouse. Sensors in the warehouse are able to detect the change in temperature conditions, oxygen conditions, lighting conditions, or any other environmental conditions. These sensors produced sensor data 1205, which is transmitted to the service 1210, which is representative of service 205 from FIG. 2. Service 1210 is able to analyze the sensor data 1205 and determine that a fire (or any other occurrence) is happening. In response, service 1210 is able to raise an alarm 1215 or alert to notify a responsible party. The above example may be considered as a type of potentially catastrophic example. A person skilled in the art will appreciate how less severe example scenarios are also covered by these principles. For instance, a particular asset may shut down due to certain conditions, such as perhaps overheating or exhaustion of a particular supply. The embodiments are able to determine when such events happen and trigger alerts based on those events. In some cases, alerts can be triggered when a technician reports a finding. Accordingly, different levels of severity can be detected and acted upon or in response to their detection.

### Example User Interfaces

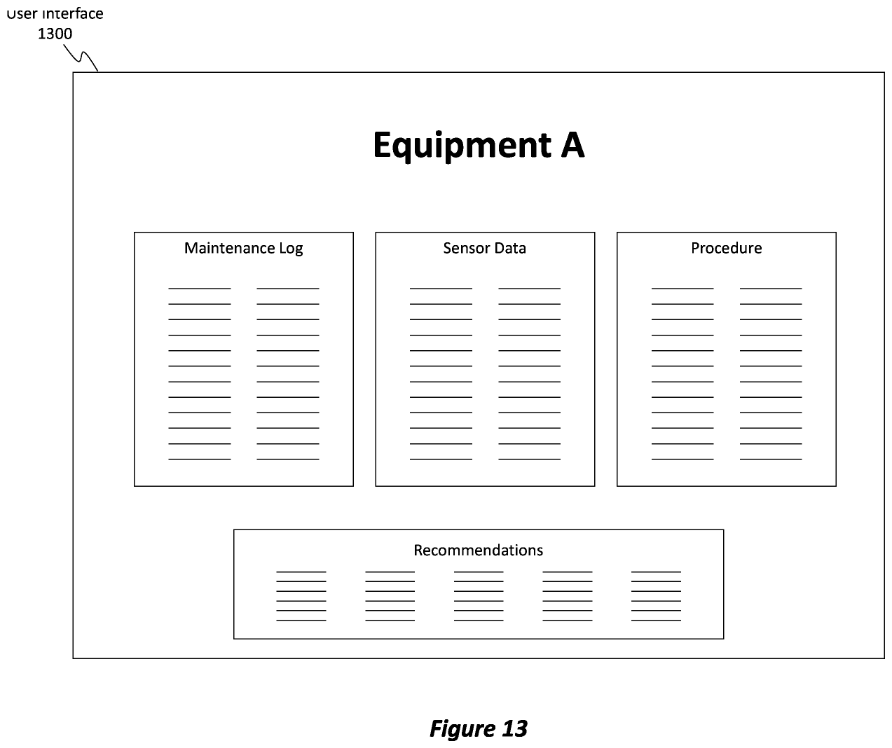

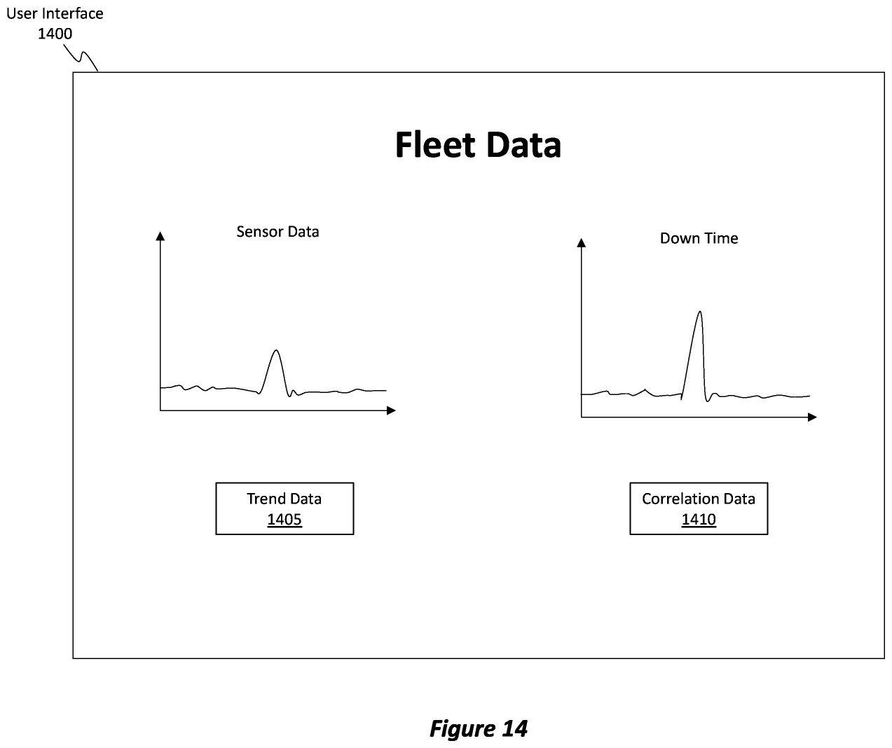

Attention will now be directed to FIGS. 13 and 14, which illustrate various examples of some user interfaces that may be displayed or surfaced. FIG. 13 shows a user interface 1300 that may be presented to a consumer using the asset management platform 210 of FIG. 2. User interface 1300 is shown as including various different pieces of information. Examples of such information include, but are not limited to, details regarding when an asset was maintained (e.g., recorded in the maintenance log), details regarding data obtained from sensors (e.g., recorded in the sensor data), details regarding procedures for an asset (e.g., recorded in the procedure), and details regarding various recommendations that may be generated (e.g., recorded in the recommendations).

FIG. 14 shows an example user interface 1400 that may be shown to a user of the package authoring platform 245 of FIG. 2. User interface 1400 can be used to author various packages. User interface 1400 can also display information about various assets. Such information includes, but is not limited to, sensor data, trend data 1405, down time, and correlation data 1410. For instance, FIG. 14 shows a plot of sensor data. Notice, there is a peak in the sensor data near the middle of the graph. Similarly, there is a peak in the chart of the down time. A review of the sensor data and the down time may unveil a correlation between the peak in the sensor data and the peak in the down time. For instance, the sensor data shows an anomaly occurring in the central area of the graph. It is likely that the anomaly caused the down time for the asset. The embodiments are able to analyze the sensor data and generate correlations and predictions based on that data.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

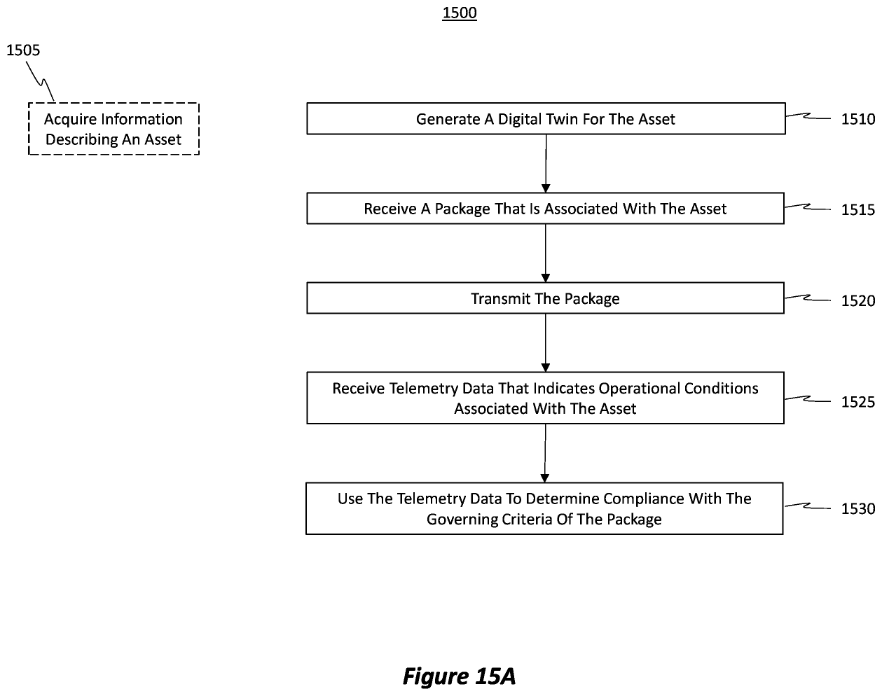

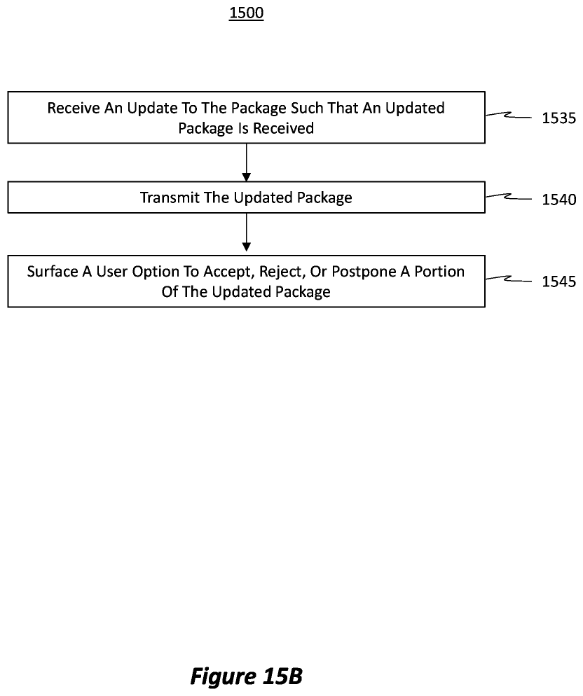

Attention will now be directed to FIGS. 15A and 15B, which illustrate flowcharts of an example method 1500 for propagating a package from a package authoring platform (e.g., package authoring platform 245 of FIG. 2) to an asset management platform (e.g., asset management platform 210 of FIG. 2). Method 1500 may be implemented by service 205 of FIG. 2.

Method 1500 includes an act (act 1505) of acquiring, from the asset management platform, information describing an asset (e.g., asset 220 of FIG. 2). That information may include any of the data 300 from FIG. 3. In some instances, the information describing the asset may include one or more of: a make of the asset, a model of the asset, a position of the asset, or a proximity of the asset to another asset. Act 1505 is shown as being a separate box that is located outside of the remaining sections of the flow chart. Act 1505 is also shown as being in a dashed line box. The dashes demonstrate how act 1505 is an optional act that is not necessarily required. Furthermore, act 1505 is shown outside of the flow chart to illustrate how this operation, which is optional, can be performed asynchronously with respect to the other acts.

By way of further clarification, consider how traditional software packages are updated. The developer asynchronously and independently creates an update to a package or perhaps creates a whole new package for an asset. That update is not dependent on what applications customers may have; rather, the update is generated for a particular application. After the update is authored, it is then rolled out or transmitted to whichever customers have that particular application. Thus, the initial creation of the update is not dependent on client information. Determining to whom the update will be transmitted may be dependent on client information, but the actual authoring of the update is not dependent on client information.

In some scenarios, the service includes a machine learning (ML) engine. The ML engine can use data (e.g., perhaps telemetry data) to submit a recommendation to the asset management platform. Optionally, the recommendation may include one or more of: a recommendation as to a new position for the asset, a recommendation as to when the asset is to be serviced, or a recommendation as to when a supply for the asset is to be replenished. As another option, the data (e.g., perhaps telemetry data) may include one or more of: image data, environmental conditions data, or instrumentation data. A recommendation may be generated based on the telemetry data.

Act 1510 includes generating a digital twin (e.g., digital twin 240 of FIG. 2) for the asset. Notably, the digital twin is a digital representation of the asset.

Act 1515 includes receiving, from the package authoring platform, a package (e.g., package 250). This package is associated with an asset. The package also outlines a set of governing criteria (e.g., governing criteria 250A) for the asset. Optionally, the package may include one or more of: parts data for the asset, procedure data for the asset, a work order template for the asset, vendor data for the asset, or instrumentation data for the asset. In some instances, the governing criteria for the asset includes one or more of compliance data with respect to a regulation associated with the asset or performance information associated with the asset. In some instances, the package is a nested or embedded package in which one or more additional packages are nested or embedded therein.

Although not included in FIG. 15, method 1500 may include an act of determining which customers or clients have the asset for which the package has been authored or updated. Thus, the embodiments may determine that the asset management platform is tracking the asset and is thus an entity to which the authored package (or an update) should be delivered. In some cases, this determination is based on the information that was obtained as a part of act 1505. Thus, the package is independently authored and/or updated with respect to information that may be obtained relating to which clients have the actual asset. Stated differently, an asset's package is authored and/or updated on the OEM side even if no information is currently available as to which clients have the asset. Later, the service may attempt to determine which clients actually have the asset so that the package or update can be properly delivered to those clients.

Act 1520 includes transmitting the package to the asset management platform. For instance, the package authoring platform transmits the package to the service 205. Service 205 is then able to transmit the package to the asset management platform 210. In some cases, transmitting the package is performed in response to a download request received from the asset management platform.

For example, in some cases, the process of transmitting the package to the asset management platform includes providing a scannable code or other information to the client so the client can access or download the package, such as from the service. For instance, the scannable code may be a QR code or perhaps a URL link. Any type of scannable or clickable code or link may be used.

Act 1525 includes receiving, from the asset management platform, telemetry data (e.g., telemetry data 305 from FIG. 3). This telemetry data indicates operational conditions associated with the asset. In some implementations, the telemetry data includes one or more of: sensor data from a sensor external relative to the asset (e.g., perhaps a camera aimed at the asset) or sensor data from a sensor associated with the asset (e.g., perhaps a sensor included as a part of the asset, such as a pressure gauge). Thus, the embodiments facilitate a two-way update process. For instance, one update involves a package being authored or updated and being transmitted to the client, thereby updating the client. Another update involves the client providing telemetry data to the OEM, thereby updating the OEM. Thus, there is a two way update process, which is facilitated by the service, between the OEM and the client/customer.

Act 1530 then involves using the telemetry data to determine compliance with the governing criteria of the package. For instance, the telemetry data may include sensor data, maintenance data, preventative care data, and so on. That data can be used to determine whether the governing criteria included in the package is being satisfied.

Method 1500 continues in FIG. 15B. For example, act 1535 includes receiving, from the package authoring platform, an update to the package. The service may receive this update. Consequently, an updated package is received at the asset management platform.

Act 1540 includes transmitting the updated package to the asset management platform. For instance, the service may transmit the updated package to the asset management platform.

Act 1545 includes surfacing a user option to accept, reject, or postpone a portion of the updated package. For instance, a user interface showing the information presented in FIG. 6 can be provided to a user, and the user can elect to accept, reject, or postpone portions of the updated package.

In some embodiments, method 1500 further includes an act of receiving feedback data from the asset management platform. Another act involves modifying, based on the feedback data, the package. Yet another act involves propagating the package to a different platform that is identified as having a similar asset as the current asset.

Another act may include acquiring data from one or more other platforms having other assets that are identified as being similar to the current asset. The embodiments may then compile fleet data that corresponds to the current asset and those other assets.

Optionally, a user interface may be provided to a user. The user interface may include a feature for displaying deltas that exist between the package and the updated package. In some scenarios, the user interface further includes a feature for receiving user input from the user. The user input may include one of an acceptance, a rejection, or a postponement for at least one delta included in those deltas. Thus, in some embodiments, the package is periodically updated by the package authoring platform, and those updates can be acted on by a user of the asset management platform.

In some cases, method 1500 may further include providing a prediction to the asset management platform. The prediction can optionally relate to a supply chain for the asset.

### Additional Details

When installing a package, the disclosed solutions allow a consumer to select which components are to be installed. Components that are considered to be “core” components may require installation. For instance, a step included in a standard operating procedure focused on health and safety provided by OSHA may be considered a core component and may require installation. However, it is possible that a consumer can select between variants of the same procedure or group of procedures based on different factors, such as regulations, team composition, and environment.

For example, a specific piece of equipment might have a different set of maintenance procedures depending on whether the equipment is installed indoors or outdoors. In some scenarios, most of those procedures will be pre-configured by the equipment manufacturer for each respective customer, or at least each respective class of customer, so the solution is as turn-key as possible. That being said, these components and procedures can be modified locally by the customer through symbol properties without detaching the symbol from its main author. FIG. 6 described a scenario in which certain components or procedures can be modified locally. In some instances, when a component is locally modified, a notification is transmitted to the service 205 and/or the package authoring platform 245 so a record of such a change can be maintained.

During installation of an asset, it is possible to associate symbols from the package to existing entities. For example, a package may attempt to install a component for spare parts. If, however, the consumer already has some compatible parts on-hand, the embodiments can map the component for that part to the one the consumer already has in order to fulfill that functionality. That component would thus preserve its functional link with other components of the package. Therefore, if the package also installed a maintenance procedure involving the replacement of the part, the ones the consumer designated will be used when subtracting inventory or when ordering new replacements.

As mentioned earlier, the embodiments are flexible enough to allow embedding of component symbols inside each other as building blocks in an ecosystem and to allow data flows in any direction. To illustrate this, consider an example where the CDC (Center for Disease Control and Prevention) publishes a standard operating procedure documenting the steps and instructions that need to be followed to deal with a specific virus or health risk from their perspective and mission of equitably protecting health, safety, and security.

A regulating body (such as OSHA) would install that symbol as part of their own standard operating procedure, and they surround it with extra steps and instructions that are in line with their own mission of ensuring safe and healthful working conditions for workers.

Following that, a manufacturing company can put together a certain procedure documenting how to maintain a piece of equipment they are manufacturing, where that equipment has to be compliant with certain OSHA regulations. At that point, the manufacturer would install the official symbol that OSHA published to cover those regulations and would make it a part of their own package, again prepending and/or appending additional steps and instructions that would be specific either to their business, industry, or even to that specific piece of equipment.

Finally, that manufacturer's customers, upon receipt of the equipment, would install the software package that is bundled with it. The customer/consumer would conduct maintenance and repairs using instructions that have seamlessly been assembled from a chain of sources, both governmental and corporate in this case.

Updates can also trickle down the symbol chain that was just presented. To continue with the above example, consider a scenario where the CDC might have learned more information about a specific virus out of scientific research. The CDC may desire to update the procedure it had previously built to account for this new knowledge. After doing the required edits, the CDC may publish a new version of its standard operating procedure. Then, OSHA, being the next entity down the chain, would be notified that a new version is available for one of the packages they depend on in their own packages. OSHA would be presented with a view showcasing the differences between their current version of the CDC package and the one they are trying to update to. OSHA would be able to apply the update and publish a new version of their own package.

This would lead to a similar update flow for the manufacturer and eventually for their customers. It might be the case that these customers have multiple packages installed for multiple pieces of equipment, potentially coming from different manufacturers. The more composition there is, the more scrutiny and selectivity there needs to be on how and when updates are applied. That is why it is possible to locally select which packages and components are to be updated when examining the differential comparison mentioned above. Reasons for postponing or skipping a component update can be varied, but incompatibility with another package or a known issue with a specific version may be cited as examples.

The above discussion focused on scenarios describing how data flows “down” the symbol chain. Data can also flow “up” the chain, however.

For instance, consider a scenario where a piece of hardware is deployed to a customer of a manufacturer. This hardware can be analogized to a data container that stays connected to the backend. Often, there is a constant stream of data that flows back up the package chain, with the goal of providing proper logging and monitoring to the owner and publisher of each package.

The manufacturer might be interested to know about the usage of parts, especially around how and where they were used to execute maintenance and servicing work, as opposed to how many were in the customer's inventory and when they were used. This could help understand what subsystems of a piece of hardware are more prone to failure and may subsequently drive the decision to harden those in future iterations. Knowing about the usage of parts could also play a role in the manufacturer helping its customers replenish their inventories, either directly or through partnerships, to ensure they at least have the critical amount on hand, especially when the lead times are longer.

Other examples of data flowing back to the manufacturer include the historical uptime and downtime trail of assets, current and historical readings from IoT (Internet of Things) sensors (or even from manual entry), and PLC (Programmable Logic Controller) of the equipment. The embodiments are able to acquire a 360 degree view for each piece of horizontally deployed hardware. The embodiments are further able to identify patterns, trends, and anomalies that might help inform either immediate servicing recommendations and/or future updates/iterations on the hardware itself, as well as on its published package(s).

Another piece of relevant information flowing back up may include the information filled while following procedures and the pace of completion of workflows. This kind of information will allow manufacturers to take a horizontal look at their distributed fleet for a specific piece of hardware and to identify potential process improvements.

For example, if the manufacturer notices that a specific procedure is regularly getting completed 10 minutes faster across the same 25% of the fleet, the manufacturer may desire to investigate why that is. Using the acquired data, the manufacturer may be able to draw conclusions and potentially even submit recommendations to other consumers. Notably, manufacturers may first want to make sure that there is no negligence happening that could put the health and safety of workers at risk, in which case any presumed “improvement” or “speed-up” in a procedure will be dismissed and the troublesome behavior will be reported.

However, once all potential process faults are cleared, the manufacturer will be able to study this significant performance gain from all possible angles, which include: data, customer interviews, and so on. The manufacturer might find out that a subset of wise workers has identified that if a swap in some of the steps in the procedure was made, the work actually becomes easier to perform. If there is no delta on the riskiness of a potential maneuver change, then that change may be highly beneficial to incorporate into future iterations of a procedure. Thus, this change can be propagated down the chain to ultimately benefit the end customers.

With respect to the previous OSHA example, regulatory bodies will also benefit from procedure answers and completion performance flowing back upstream. For example, it is possible to detect if there is risky behavior happening (and even to quantify how risky it is) based on answers (or lack thereof) of a standard operating procedure around health and safety that would have been distributed through an official OSHA package. In the most critical of cases, that information could even be used to intervene and prevent an imminent work accident. In a more general capacity, it could help grade organizations on their observation and compliance of OSHA standards, help conduct regular and even automated audits, and so on.

The disclosed embodiments beneficially empower and enable users and maintainers to contribute back and share improvements and fixes to their hardware packages. A package user can decide to detach some components from their origin symbol so they can either adapt them to their needs that are too specific or so they can improve them and contribute those improvements back upstream.

Accordingly, the disclosed embodiments fill numerous gaps in operations involving hardware assets. Now, hardware manufacturers and regulators will be empowered to deploy, update, and monitor their equipment or regulations in a horizontal fashion to all their customers. Advantageously, the disclosed solutions help to bring in better visibility on day-to-day operations and usage of hardware, with better guarantees around reliability, performance, health and safety, and machine learning insights into performance, efficiency, and possible future improvements.

### Example Computer/Computer Systems

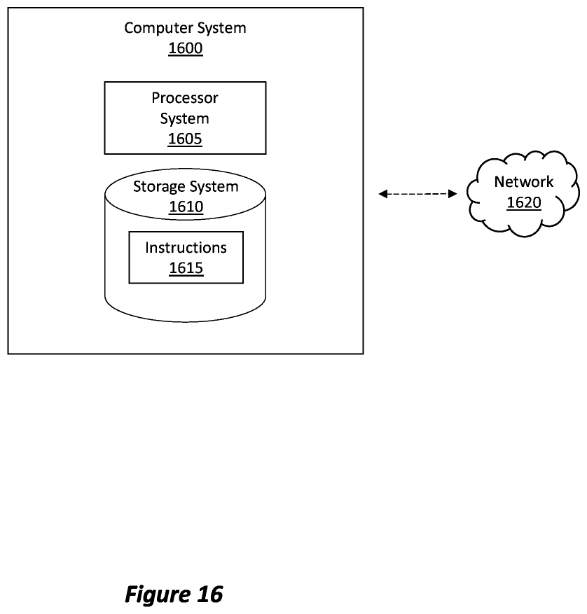

Attention will now be directed to FIG. 16 which illustrates an example computer system 1600 that may include and/or be used to perform any of the operations described herein. Computer system 1600 may take various different forms. For example, computer system 1600 may be embodied as a tablet, a desktop, a laptop, a mobile device, or a standalone device, such as those described throughout this disclosure. Computer system 1600 may also be a distributed system that includes one or more connected computing components/devices that are in communication with computer system 1600.

In its most basic configuration, computer system 1600 includes various different components. FIG. 16 shows that computer system 1600 includes a processor system 1605 that includes one or more processor(s) (aka a “hardware processing unit”) and a storage system 1610.

Regarding the processor(s) of the processor system 1605, it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 1600. The different components, modules, engines, and services described herein may be implemented as objects or processors that execute on computer system 1600 (e.g. as separate threads).

Storage system 1610 may be physical system memory, which may be volatile, non-volatile, or some combination of the two. The term “memory” may also be used herein to refer to non-volatile mass storage such as physical storage media. If computer system 1600 is distributed, the processing, memory, and/or storage capability may be distributed as well.

Storage system 1610 is shown as including executable instructions 1615. The executable instructions 1615 represent instructions that are executable by the processor(s) of the processor system 1605 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1600 may also be connected (via a wired or wireless connection) to external sensors (e.g., one or more remote cameras) or devices via a network 1620. For example, computer system 1600 can communicate with any number devices or cloud services to obtain or process data. In some cases, network 1620 may itself be a cloud network. Furthermore, computer system 1600 may also be connected through one or more wired or wireless networks to remote/separate computer systems(s) that are configured to perform any of the processing described with regard to computer system 1600.

A “network,” like network 1620, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1600 will include one or more communication channels that are used to communicate with the network 1620. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for propagating a package over a network from a package authoring platform to a remote asset management platform, said method further facilitating management of an asset associated with the package by tracking a state of the asset in a facility, said method being implemented by a service and comprising:
generating a digital twin for the asset, wherein the digital twin is a digital representation of the asset;
receiving, from the package authoring platform, the package that is associated with the asset, wherein the package outlines a set of governing criteria for the asset, wherein the package includes an installed symbol generated by a source that is different than the package authoring platform such that the package is assembled from a chain of multiple sources, and wherein a portion within the package includes a reference to the symbol, said reference being structured to facilitate selective updating to the package;
providing a code to the asset management platform, the code being structured to facilitate, over the network, installation of the package at the asset management platform;
transmitting the package to the asset management platform for installation of the package at the asset management platform;
receiving, from the asset management platform, telemetry data that indicates operational conditions associated with the asset;
using the telemetry data to determine compliance with the governing criteria of the package;
receiving an update designed for the symbol within the package, the update originating from the source that is different than the package authoring platform such that the update passed through the chain of multiple sources until reaching the service, wherein the update is generated asynchronously and without a dependence on a determination as to which one or more asset management platforms include the symbol;
selecting the portion that includes the reference to the symbol;
applying the update to the symbol within the selected portion, resulting in generation of a selectively updated package;
determining that, as a result of the asset management platform having previously installed the package, the update to the symbol is applicable to the package installed at the asset management platform;
publishing the selectively updated package to the asset management platform, wherein the selectively updated package, after being received at the asset management platform, is caused to be installed at the asset management platform;
accessing image data obtained from a plurality of cameras disposed within the facility, wherein the image data reflects a supply of materials located within the facility, wherein the supply of materials is used by the asset, and wherein an inventory database maintains an inventory record for the supply of materials;
determining a usage characteristic from the image data for the supply of materials to form a monitored usage of the supply of materials by the asset over time such that the service tracks the monitored usage of the supply of materials via the image data;
based on the usage characteristic, predicting a first date when the supply of materials is likely to run out;
based on the predicted data, determining a second date when more of the supply of materials is to be ordered to avoid running out of the supply of materials;
generating a recommendation using the determined second date, the recommendation indicating that more the supply of materials is to be ordered prior to the first date to enable the asset to continue to operate using the supply of materials; and
changing the inventory record in the inventory database to reflect an updated amount of the supply of materials when the amount of the supply of materials changes.

2. The method of claim 1, wherein information describing the asset is available to the service and includes one or more of: a make of the asset, a model of the asset, a position of the asset, or a proximity of the asset to another asset.

3. The method of claim 1, wherein the package includes one or more of: parts data for the asset, procedure data for the asset, a work order template for the asset, vendor data for the asset, or instrumentation data for the asset.

4. The method of claim 1, wherein the governing criteria for the asset includes one or more of compliance data with respect to a regulation associated with the asset or performance information associated with the asset.

5. The method of claim 1, wherein the method further includes:
surfacing a user option to accept, reject, or postpone a portion of the updated package.

6. The method of claim 1, wherein the package is a nested package in which one or more additional packages are nested therein.

7. The method of claim 1, wherein the telemetry data includes one or more of: sensor data from a sensor external relative to the asset or sensor data from a sensor associated with the asset.

8. The method of claim 1, wherein the asset management platform includes a plugin component that facilitates communications between the asset management platform and the service, and wherein the service is a cloud service.

9. The method of claim 1, wherein the service includes a machine learning (ML) engine, and wherein the ML engine submits the recommendation to the asset management platform.

10. The method of claim 9, wherein the recommendation further includes one or more of: a recommendation as to a new position for the asset, or a recommendation as to when the asset is to be serviced.

11. A computer system that propagates a package over a network from a package authoring platform to a remote asset management platform, the computer system being further configured to facilitate management of an asset associated with the package by tracking a state of the asset in a facility, said computer system comprising:
a processor system; and
a storage system that stores instructions that are executable by the processor system to cause the computer system to:
receive, from the package authoring platform, the package that is associated with the asset, wherein the package outlines a set of governing criteria for the asset, wherein the package includes an installed symbol generated by a source that is different than the package authoring platform such that the package is assembled from a chain of multiple sources, and wherein a portion within the package includes a reference to the symbol, said reference being structured to facilitate selective updating to the package;
provide a code to the asset management platform, the code being structured to facilitate, over the network, installation of the package at the asset management platform;
transmit the package to the asset management platform for installation of the package at the asset management platform;
receive, from the asset management platform, telemetry data that indicates operational conditions associated with the asset;
use the telemetry data to determine compliance with the governing criteria of the package;
receive an update designed for the symbol within the package, the update originating from the source that is different than the package authoring platform such that the update passed through the chain of multiple sources until reaching the service, wherein the update is generated asynchronously and without dependence on a determination as to which one or more asset management platforms include the symbol;
select the portion that includes the reference to the symbol;
apply the update to the symbol within the selected portion, resulting in generation of a selectively updated package;
determine that, as a result of the asset management platform having previously installed the package, the update to the symbol is applicable to the package installed at the asset management platform;
publish the selectively updated package to the asset management platform, wherein publishing the selectively updated package to the asset management platform causes installation of the selectively updated package at the asset management platform;
access image data obtained from a plurality of cameras disposed within the facility, wherein the image data reflects a supply of materials located within the facility, wherein the supply of materials is used by the asset, and wherein an inventory database maintains an inventory record for the supply of materials;
determine a usage characteristic from the image data for the supply of materials to form a monitored usage of the supply of materials by the asset over time such that the service tracks the monitored usage of the supply of materials via the image data;
based on the usage characteristic, predict a first date when the supply of materials is likely to run out;
based on the predicted data, determine a second date when more of the supply of materials is to be ordered to avoid running out of the supply of materials;
generate a recommendation using the determined second date, the recommendation indicating that more the supply of materials is to be ordered prior to the first date to enable the asset to continue to operate using the supply of materials; and
change the inventory record in the inventory database to reflect an updated amount of the supply of materials when the amount of the supply of materials changes.

12. The computer system of claim 11, wherein the instructions are further executable by the processor system to cause the computer system to:
receive feedback data from the asset management platform;
modify, based on the feedback data, the package; and
propagate the package to a different platform that is identified as having a same asset as said asset.

13. The computer system of claim 11, wherein the instructions are further executable by the processor system to cause the computer system to:
acquire data from one or more other platforms having other assets that are identified as being the same to said asset; and
compile fleet data that corresponds to said asset and said other assets.

14. The computer system of claim 11, wherein the telemetry data includes one or more of: image data, environmental conditions data, or instrumentation data.

15. The computer system of claim 11, wherein a second recommendation is generated based on the telemetry data.

16. A method for propagating a package over a network from a package authoring platform to a remote asset management platform, said method further facilitating management of an asset associated with the package by tracking a state of the asset in a facility, said method being implemented by a service and comprising:
generating a digital twin for the asset, wherein the digital twin is a digital representation of the asset;
receiving, from the package authoring platform, the package that is associated with the asset, wherein the package outlines a set of governing criteria for the asset, wherein the package includes an installed symbol generated by a source that is different than the package authoring platform such that the package is assembled from a chain of multiple sources, and wherein a portion within the package includes a reference to the symbol, said reference being structured to facilitate selective updating to the package;
providing a code to the asset management platform, the code being structured to facilitate, over the network, installation of the package at the asset management platform;
in response to a download request received from the asset management platform via use of the code, transmitting the package to the asset management platform for installation of the package at the asset management platform;
receiving, from the asset management platform, telemetry data that indicates operational conditions associated with the asset, wherein the telemetry data includes sensor data from a sensor;
using the telemetry data to determine compliance with the governing criteria of the package;
receiving an update designed for the symbol within the package, the update originating from the source that is different than the package authoring platform such that the update passed through the chain of multiple sources until reaching the service, wherein the update is generated asynchronously and without a dependence on a determination as to which one or more asset management platforms include the symbol;
selecting the portion that includes the reference to the symbol;
applying the update to the symbol within the selected portion, resulting in generation of a selectively updated package;
determining that, as a result of the asset management platform having previously installed the package, the update to the symbol is applicable to the package installed at the asset management platform;
publishing the selectively updated package to the asset management platform, wherein publishing the selectively updated package to the asset management platform triggers installation of the selectively updated package at the asset management platform;
accessing data obtained from one or more sensors disposed within the facility, wherein the data reflects a supply of materials located within the facility, wherein the supply of materials is used by the asset, and wherein an inventory database maintains an inventory record for the supply of materials;
determining a usage characteristic from the data for the supply of materials to form a monitored usage of the supply of materials by the asset over time such that the service tracks the monitored usage of the supply of materials via the data;
based on the usage characteristic, predicting a first date when the supply of materials is likely to run out;
based on the predicted data, determining a second date when more of the supply of materials is to be ordered to avoid running out of the supply of materials;
generating a recommendation using the determined second date, the recommendation indicating that more the supply of materials is to be ordered prior to the first date to enable the asset to continue to operate using the supply of materials; and
changing the inventory record in the inventory database to reflect an updated amount of the supply of materials when the amount of the supply of materials changes.

17. The method of claim 16, wherein a user interface is provided to a user, and wherein the user interface includes a feature for displaying deltas that exist between the package and the updated package.

18. The method of claim 17, wherein the user interface further includes a feature for receiving user input from the user, the user input comprising one of an acceptance, a rejection, or a postponement for at least one delta included in said deltas.

19. The method of claim 16, wherein the method further includes providing a prediction to the asset management platform, and wherein the prediction relates to a supply chain for the asset.

20. (canceled)

21. The method of claim 16, wherein the one or more sensors include a non-image based sensor.
